(19) United States
(12) Patent Application Publication
(10) Pub. No.: US 2016/0237947 A1
(43) Pub. Date: Aug. 18, 2016

(54) REGENERATOR FOR AN EXTERNAL HEAT ENGINE

(71) Applicant: ECOTECH ENGINES AG, Chur (CH)

(72) Inventors: Alexander Victorovich NOSKOV, Chur (CH); Alexander Ivanovich ACKIMOV, Chur (CH); Arteom Pavlovich IGNATENKO, Chur (CH)

(73) Assignee: ECOTECH ENGINES AG, Chur (CH)

(21) Appl. No.: 15/029,295

(22) PCT Filed: Sep. 27, 2014
(86) PCT No.: PCT/EP2014/002623

§ 371 Date: Apr. 14, 2016

(30) Foreign Application Priority Data
Oct. 25, 2013 (EP) EP1340 5122.6

(51) Int. Cl. F02G 1/057; F28F 7/02; F28F 13/08; F28D 17/02; F28F 1/02

(52) U.S. Cl. CPC F02G 1/057; F28D 17/02; F28F 1/022; F28F 13/08; F28F 7/02

(57) ABSTRACT

There is described a regenerator (5) for an external heat engine, in particular for a Stirling engine, which is adapted for being mounted in the passageway for a working fluid moving from the hot side of the engine to a cold side of the engine and vice versa. The regenerator (5) is capable of receiving and temporarily storing heat, which is deposited by the working fluid when it passes through the regenerator (5), on its way from the hot side to the cold side of the engine, and of releasing heat to the working fluid again when it passes through the regenerator (5) on its way from the cold side to the hot side of the engine. The regenerator (5) comprises at least one through channel (50) which is tapered along an axial extension thereof from a hot side port to a cold side port of the through channel (50), so that the working fluid which flows along the through channel (50) is maintained under a generally constant pressure.

### CROSS-REFERENCE TO RELATED APPLICATIONS

This application is a national stage patent application of International Application No. PCT/EP2014/002623, filed Sep. 27, 2014, entitled “REGENERATOR FOR AN EXTERNAL HEAT ENGINE”, which claims priority to European Patent Application No. 13405122.6, filed Oct. 25, 2013.

### BACKGROUND

The current invention relates to a regenerator for an external heat engine, in particular for a Stirling engine, in accordance with the introductory clause of patent claim 1.

An external heat engine, in particular a Stirling engine, is, in principle, a heat engine operating due to cyclic compression and expansion of a working fluid, such as, e.g., air, helium, hydrogen or other gases. Cyclic compression and expansion of the working fluid is performed at different temperature levels, so that there is a direct conversion of externally provided heat energy into mechanical work. It may also be designated by a closed-cycle, preferably regenerative, heat engine with a permanently working gaseous fluid. The term “closed-cycle” can be defined as a certain thermodynamic system in which the working fluid is permanently contained within the system. “Regenerative” refers to the provision of a specific type of internal heat exchanger and heat storage system, known as a regenerator. It is the inclusion of a regenerator that differentiates a Sterling engine from other known closed-cycle hot air engines.

The regenerator is an internal heat exchanger and temporary heat storage. It is located in between the hot and cold parts of the external heat engine, respectively, so that the working fluid passes through it moving from the hot part of the engine to its cold part and back again. Its function is to retain within the system that heat of the working fluid which would otherwise be exchanged with the environment. Thus, when coming from the hot side of the external combustion heat engine the working fluid deposits heat into the regenerator, and when flowing back again from the cold side of the external combustion heat engine the external engine it picks up heat again from the regenerator.

The primary effect of the regenerator is to increase the thermal efficiency by maintaining and “recycling” the internal heat of the system which would otherwise be irreversibly lost. One problem with this regenerator types known from the prior art is that they introduce too much additional volume, which contributes to the dead space of the engine. The dead space in the external heat engine results in a loss of the usable pressure difference in the working fluid, thereby reducing thermodynamic and mechanical efficiency of the system. Another type of regenerator that uses a stack of fine metal wire meshes has the problem of creating turbulences in the working fluid when flowing through the regenerator. These turbulences contribute to the flow resistance of the working fluid, which results in a negative contribution to the thermal efficiency of the heat engine.

It is therefore an object of the present invention to provide a remedy to the disadvantages of the regenerators known from the prior art. A regenerator shall be provided which enables an efficient and sufficiently high heat transfer to and from the gaseous working fluid without introducing too much additional internal volume or flow resistance. A regenerator shall be provided, which also allows the use of heavier gases, such as, e.g., air as the working fluid. The regenerator shall have a relatively simple configuration and shall be compatible with different types of external heat engines, in particular with Stirling engines of the Alfa or Beta type.

### SUMMARY

These and still further objects in the context with the above subject matter are met by a regenerator according to the invention which comprises the features listed in patent claim 1. Further improvements thereof and advantageous and preferred embodiments of the invention are subject of the dependent claims.

Thus, in accordance with the present invention a regenerator for an external heat engine, in particular for a Stirling engine, is provided, which is adapted for being mounted in the conduit for a working fluid passing from the hot part of the engine to its cold part. The regenerator is capable of receiving and temporarily storing heat, which is deposited by the working fluid when it passes through the regenerator on its way from the hot side to the cold side of the engine, and then, the regenerator is capable of releasing heat into the working fluid again when the working fluid passes through the regenerator, on its way from the cold side to the hot side of the engine. The regenerator comprises at least one through channel which is tapered along its axial extension thereof from a hot side port to a cold side port of the through channel in such a way, that the working fluid which flows along the through channel is maintained under a generally constant pressure.

By providing the regenerator with at least one through channel that tapers from the hot side port to the cold side port of the through channel, it is taken into account that during operation the working fluid arrives at the hot side port from the hot side of the engine at an elevated temperature. And consequently, the working fluid tends to expand and take in a greater volume, or, under a constant volume available exerts a higher pressure. During its passage through the through channel the working fluid deposits its heat to the regenerator. As a consequence of its temperature being decreased, the volume of the working fluid contracts and its pressure decreases. Decreasing pressure means that fewer molecules per unit area reach the side walls of the through channel. Thus, with decreasing temperature of the working fluid the heat exchange with the side walls of the the through channel of the regenerator is also reduced.

With a tapered through channel the temperature-induced pressure decrease can be counteracted. By selecting the degree of taper of the through channel such, that the working fluid that flows along the through channel is maintained under a generally constant pressure, the number of molecules reaching the channel walls can be kept about constant, and the heat exchange efficiency in the regenerator may be increased considerably. This effect occurs not only with the working fluid travelling through the through channel from the hot side to the cold side of the external heat engine, but it is repeated when the working fluid flows through the through channel in the opposite direction, from the cold side to the hot side of the external heat engine. Once in contact with the walls of the through channel the working fluid takes up heat. As its temperature is being increased the working fluid expands. The cross-section of the through channel enlarges in a manner corresponding to the volume increase of the working fluid. Thus, the pressure of the working fluid within the through channel of the regenerator is maintained about constant. An increase in flow resistance due to an abrupt pressure increase is avoided. The tapered shape of the through channels avoids a dilution effect as the working fluid streaming from the hot side to the cold side of the external heat engine is cooled; and it avoids a sealing effect as the working fluid is being heated when it streams the opposite direction, from the cold side to the hot side of the engine. Turbulances in the working fluid remain about constant and are controllable. The through channel is free from any obstacles like wire meshes and the like. Therefore, uncontrolled additional turbulences may be avoided. The construction of the regenerator is relatively simple and necessitates only the formation of at least one through channel which tapers from the hot side port to the cold side port thereof.

In a very simple design of the regenerator, the through channel may be tapered continuously or linearly. The background of such an embodiment is the assumption of a linear increase in temperature and thus volume increase of the working fluid during its travel through the through channel. Alternative embodiments of the regenerator may also be provided with at least one through channel having a tapering which increases or decreases along its extension from the hot side port of the regenerator to its cold side port.

The through channel may in principle have an arbitrary cross-section. A very convenient embodiment of the regenerator, however, is provided with at least one through channel which may have a generally truncated conical shape. The mechanical realization of such shape can be relatively easily accomplished.

The through channel, having a truncated conical shape, need not have a circular cross-section. In an exemplary embodiment of the invention the through channel may have an oblong or oval cross-section, resulting in almost slot-like ports at the hot side and cold side, respectively, of the regenerator.

For the application in most configurations external heat engines, in particular Stirling engines, a regenerator may be used, in which the least one conically tapered through channel has side walls, that enclose with an axis of the through channel an angle of >0° to <45°, preferably 2° to 40°, most preferred 5° to 35°. The degree of taper may be determined by the skilled artisan depending on the temperature of the working fluid at the hot side and cold side ports of the regenerator. Tapered through channels having a generally conically shaped tapering within the above specified ranges, in accordance with the invention, fulfill the requirements of most external heat engines and the usually exploited temperature differences between the hot side and the cold side of the engine.

Depending on the desired degree of heat exchange the regenerator may be provided with a through channel, wherein the cold side port of the through channel has a cross-sectional area of 10% to <100%, preferably 15% to 80°, most preferred 20% to 65%, of the cross-sectional area of the hot side port.

In order to increase the area at which a heat exchange can occur, when the working fluid flows through the regenerator, the regenerator may comprise a plurality of tapered through channels with respective axes extending generally parallel with respect to each other. All through channels may be tapered in accordance with any of the aforementioned embodiments. It should be noted though, that for a mechanical simplicity and predictability of the regenerator efficiency all through channels may be shaped and configured alike. Thus, while depending on the cross-section of the regenerator at the hot side and of the cold side, the widths of the ports of the through channels may vary from one to another, the taper and the percentage relation of the cross-sections of the ports preferably are alike.

In an easily mountable embodiment of the regenerator the hot side ports of the plurality of channels may be provided in a hot side flange plate while the cold side ports of the plurality of channels are provided in a cold side flange plate.

In order to even better isolate the regenerator against heat losses via the surrounding environment the through channels may be enclosed by a housing. In such an embodiment of the regenerator the hot side flange plate and the cold side flange plate, respectively, form face sides of the housing.

In another embodiment of the invention, which is relatively easily to manufacture and does not require a specific separate assembly, the plurality of channels may be provided in a monolithic piece of metal. The hot side flange and the cold side flange, respectively, form face sides of this monolithic piece of metal.

In a yet further embodiment of the regenerator the hot side flange plate may be adapted for being mounted to a heating means for the hot side of the external heat engine, and the cold side flange plate may be adapted for being mounted to a cooling means for the cool side the of the external heat engine. The heating and the cooling means is preferably provided in close vicinity of the regenerator, so that a greater amount of heat can be exchanged in between the working fluid and the regenerator. It should be noted, that in such embodiment of the invention, having a maximum possible proximity of the heating means and the cooling means to the regenerator, the dead volume of the engine is reduced.

In principle, the working fluid may be a liquid or a gas. For handling purposes and for efficiency reasons a gaseous working fluid is preferred. Accordingly, the regenerator comprises a plurality of through channels, wherein each through channel is adapted for use in combination with the gaseous working fluid. The gaseous working fluid may be a gas having a high heat capacity, such as, e.g., helium or hydrogen. In order to reduce the complexity of the sealing, which e.g. may be required for helium, and in order to observe the requirements on safety measures, in the case of hydrogen as the working fluid, air is the preferred working fluid. Accordingly, through channels of the regenerator are adapted and optimized for the use in combination with air as the working fluid.

The regenerator according to any one of the embodiments as discussed in the outlines above may preferably be adapted to being mounted in the passage way of a Sterling engine of the Alpha-type. Thus, a Sterling engine of the Alpha-type preferably is equipped with a regenerator in accordance with any one of the afore-described embodiments. Such a Sterling engine displays a heat exchange which is more efficient, and it has a smoother operating characteristics than the Sterling engines of the prior art.

Further details and advantages of the present invention will become apparent from the following description of an exemplary embodiment thereof, reference being made to the schematic drawings, which are not to scale, in which:

### BRIEF DESCRIPTION OF THE DRAWINGS

FIG. 1 shows a sectional view of a Stirling engine of the alpha type including an embodiment of a regenerator according to the invention;

FIG. 2 shows the principle of a regenerator according to the invention;

FIG. 3 shows a perspective view on the hot side ports of an exemplary embodiment of the regenerator;

FIG. 4 shows a perspective view of the regenerator of FIG. 3, but with a view on the cold ports of the through channels.

### DETAILED DESCRIPTION

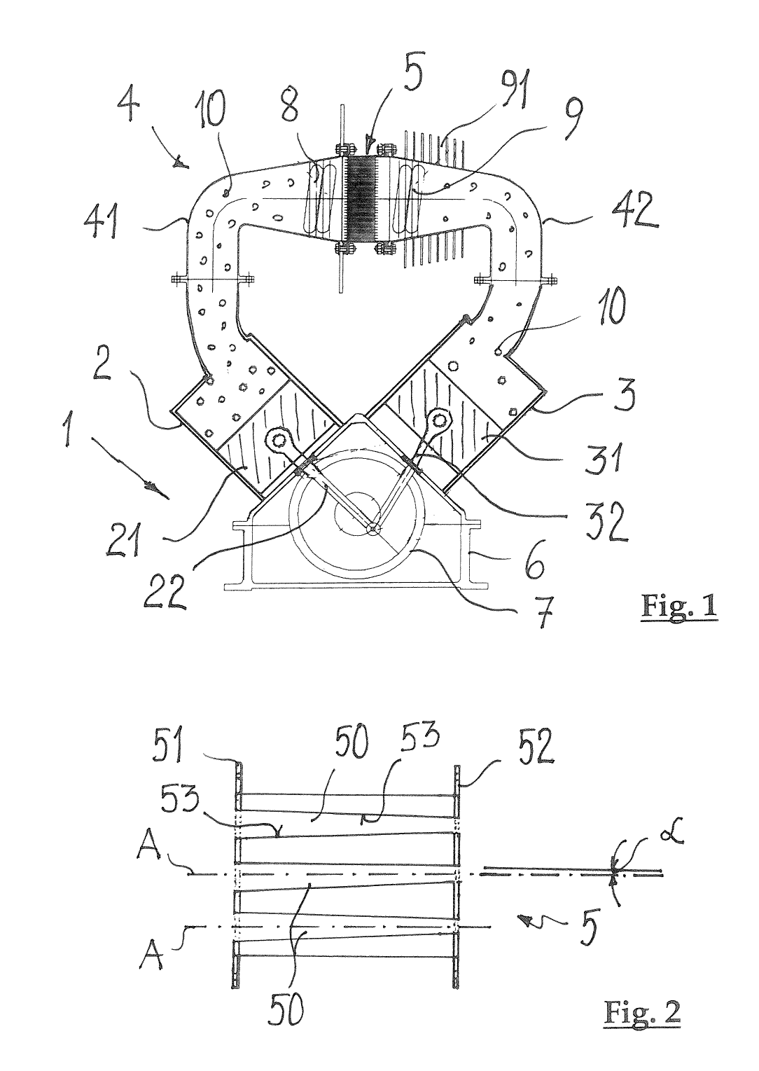

FIG. 1 shows schematically a sectional view of an alpha type Sterling engine. Stirling engines are a well-known classical type of an external heat engine and differentiate over alternatively known types of external heat engines by the inclusion of a regenerator. The Stirling engine is generally designated with reference to numeral 1. The Stirling engine 1 of the alpha type configuration comprises a first cylinder 2 and a second cylinder 3, in which respective pistons 21, 31 are moved up and down periodically. The two cylinders 2, 3 are connected via a conduit 4 for a working fluid 10 comprising a first branch tube 41 and a second branch tube 42. The cylinders 2, 3 and the conduit 4 form a closed system in which the working fluid 10, which is normally gaseous, is periodically transported from the first cylinder 2 to the second cylinder 3 and back again. The working fluid 10 may, e.g., be helium, hydrogen or air. The two cylinders 2, 3 are mounted on a housing 6, in which a flywheel 7 is supported rotatable. The flywheel 7 is connected with the pistons 21, 31 reciprocating in the respective first and second cylinders 2, 3 via piston rods 22, 32. A regenerator 5 is arranged in the conduit 4 for the gaseous working fluid 10, separating the conduit into the two tube branches 41, 42. The specific configuration and task of the regenerator 5 will be explained in more details hereinafter.

In order to operate the Stirling engine 1 one of its cylinders, in the depicted embodiment, the first cylinder 2 on the left hand side, is kept hot, while the second cylinder 3 on the right hand side is kept cool. Heating the first cylinder 2 in the hot side of the engine may be accomplished by any source of heat coming from both, conventional fuels, such as, e.g., gas, oil, petrol, etc. and alternative fuel sources, such as, e.g., solar power, geothermal power, etc. In FIG. 1 heating of the first cylinder 2 in the hot side of the engine is symbolized by a heating spiral 8. The second cylinder 3 on the cool side of the engine is kept cool by a heat sink, such as, e.g., by air circulating through cooling fins 91, which are provided on the second branch tube 42. For an even more efficient cooling of the second cylinder 3 on the cool side of the engine a cooling spiral 9 may be provided. The heating spiral 8 and the cooling spiral 9 need not be located inside the respective branch tubes 41, 42. They can also be arranged outside the conduit 4 or its branch tubes 41, 42, respectively, and be located closer to the first and the second cylinders 2, 3.

The Stirling cycle of the Stirling engine 1 can be thought of as comprising four different phases: expansion, transfer, contraction, and transfer. In the expansion phase most of the gaseous working fluid 10 has been driven into the hot side of the Stirling engine 1. The heated working fluid 10 expands and drives both pistons 21, 31 in the respective cylinders 2, 3 inwards, towards the bottom of the cylinders. The axial motion of the moving pistons 21, 31 is transferred via the piston rods 22, 23 to the flywheel 7 and is converted into rotational motion thereof. When the gaseous working fluid 10 has fully expanded, the transfer phase is reached. The gaseous working fluid 10 has expanded e.g. about 2-5 times as compared to its cold state. Most of the working fluid 10 is initially still located in the hot side of the engine. The momentum of the flywheel 7 carries the piston rods 22, 32 the next 90°, whereby the piston 21 of the first hot cylinder 2 is advanced away from the bottom of the cylinder and the piston 31 in the second cylinder 3 on the cold side of the engine is retracted further. By this motion the bulk of the gaseous working fluid 10 is transferred to the cold side of the engine. In the third phase, the contraction phase, nearly all of the working fluid 10 is now on the cold side of the engine and the cooling continues. As the working fluid 10 cools it contracts thereby drawing both pistons 21, 31 upwardly again, away from the bottoms of the first and second cylinders 2, 3. In the final transfer phase the contracted gaseous working fluid 10 is still mainly located on the cold side of the engine, at the second cylinder 3. The momentum of the flywheel carries the piston rod 32 another 90°, transferring the working fluid 10 back again to the first cylinder 2 on the hot side of the engine to complete the Sterling cycle.

On its way from the hot side of the engine to its cold side, the gaseous working fluid 10 passes through the regenerator 5 which separates the conduit 4 into the first, hot branch tube 41 and the second, cold branch tube 42. The regenerator 5 is constructed of a material that readily conducts heat, usually of some metal. In order to improve heat transfer to and from the working fluid the regenerator preferably has a large surface area. When the hot working fluid is driven through the regenerator 5, a portion of the heat is deposited into the regenerator 5. When the cooled working fluid 10 is transferred back through the regenerator 5, this heat is “reclaimed”. Thus the regenerator 5 serves as an intermediate storage for heat and it pre-cools and pre-heats the gaseous working fluid 10 on its periodic travel through the regenerator. Using the regenerator 5, the efficiency of the Stirling engine may be improved.

In FIG. 2 the principle of a regenerator 5 according to the invention is shown. The regenerator 5 comprises at least one, preferably a plurality of through channels 50 that are tapered along the axial extension thereof from a hot side port to a cold side port of each through channel 50. According to the embodiment depicted in FIG. 2 t the hot side ports of the through channels 50 are provided in a hot side flange plate 51 while the cold side ports of the through channels 50 are provided in a cold side flange plate 52. The through channels 50 extend in between the two flange plates 51, 52 which serve to connect the regenerator 5 with the hot branch tube 41 and the cold branch tube 42, respectively, of the conduit 4 for the gaseous working fluid 10 (FIG. 1). The through channels 50 have axes A which extend generally parallel to each other. The through channels are continuously tapered and have preferably the shape of a truncated cone. The conically shaped sidewalls 53 of each through channel 50 enclose an angle α with the axis A of the through channel 50, which is larger than 0° but smaller than 45°, preferably 2° to 40°, most preferred 5° to 35°.

The cold side port of the through channel 50 at the cold side flange plate 52 has a cross-sectional area which amounts from 10% to less than 100%, preferably 15% to 80°, most preferred 20% to 65%, of the cross-sectional area of the through channel 50 at the hot side port at the hot side flange plate 51. The through channels 50 may all be configured and shaped alike. The through channels 50 may be provided in a monolithic block of a suitable metal, wherein the hot side flange 51 and the cold side flange 52 form face sides of the monolithic block. Alternatively, the through channels may be formed of a separate sheet of metal that is connected with the hot side flange plate 51 and the cold side flange plate 52, respectively. The through channels 50 may be arranged within a housing. Then the hot and cold side flange plates 51, 52 form face sides of the housing.

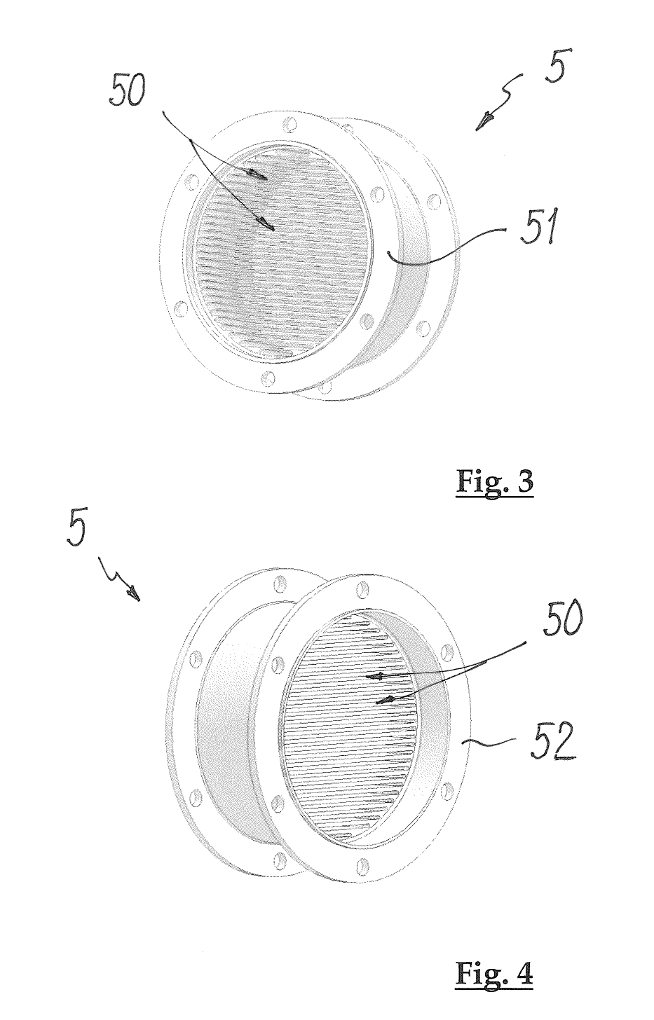

In FIG. 3 an exemplary embodiment of the regenerator 5 is shown in a perspective view on the hot side flange plate 51. A plurality of hot side ports of the through channels 50 is provided in the hot side flange plate. The through channels 50 each has an oblong or oval cross-section, resulting in almost slot-like ports at the hot side and cold side, respectively, of the regenerator. Depending on the cross-section of the regenerator 5 at the hot side and of the cold side, the widths of the ports of the through channels 50 vary from one to another. The taper and the percentage relation of the cross-sections of the ports are preferably alike.

FIG. 4 shows a perspective view of the regenerator of FIG. 3, but viewed from the cold side flange plate 52. From the drawing it can be seen that the cold side ports of the through channels 50 enclose a smaller area than the hot side ports thereof, as shown in FIG. 3.

Although the invention has been described with the reference to a specific embodiment, it is evident to the person skilled in the art that this embodiment stands only by way of example for the general inventive concept, and that various changes and modifications are conceivable without departing from the teaching underlying the invention. Therefore, the invention is not intended to be limited by the embodiment described, but rather is defined by the appended claims.

1. A regenerator for an external heat engine, in particular for a Stirling engine, which is adapted for being mounted in a conduit (4) for a working fluid (10) from a hot side (41) of the engine to a cold side (42) of the engine, and being capable of receiving and temporarily storing heat, which is deposited by the working fluid (10) when it passes through the regenerator (5) on its way from the hot side (41) to the cold side (42) of the engine, and being capable of releasing heat to the working fluid (10) again when it passes through the regenerator (5) on its way from the cold side (42) to the hot side (41) of the engine, characterized in that the regenerator comprises at least one through channel (50) which is tapered along a longitudinal axial extension thereof from a hot side port to a cold side port of the through channel (50) in such a manner, that the working fluid (10) flowing along the through channel (50) may be maintained under a generally constant pressure.

2. The regenerator according to claim 1, wherein the through channel (50) has a continuously tapered shape.

3. The regenerator according to claim 1, wherein the through channel (50) has the shape of a truncated cone.

4. The regenerator according to claim 3, wherein a side wall of the tapered through channel (50) and a longitudinal axis thereof enclose an angle (α) of larger 0° but smaller than 45°, preferably 2° to 40°, most preferred 5° to 35°.

5. The regenerator according to claim 1, wherein a cold side port of the through channel (50) has a cross-sectional area which amounts from 10% to less than 100%, preferably 15% to 80°, most preferred 20% to 65%, of the cross-sectional area of a hot side port of the through channel (50).

6. The regenerator according to claim 1, comprising a plurality of tapered through channels (50) having longitudinal channel axes (A) which extend generally parallel with respect to each other.

7. The regenerator according to claim 1, wherein each through channel (50) at its respective hot side port and/or cold side port has an oblong or oval cross-section.

8. The regenerator according to any one of claim 1, wherein each through channel (50) at its respective hot side port and/or cold side port has a circular cross-section.

9. The regenerator according to claim 6, wherein the hot side ports of the plurality of through channels (50) are provided in a hot side flange plate (51) and wherein the cold side ports of the plurality of through channels (50) are provided in a cold side flange plate (52).

10. The regenerator of claim 9, wherein the through channels (50) are enclosed within a housing, and wherein the hot side flange plate (51) and the cold flange plate (52) are two face sides of the housing.

11. The regenerator of claim 9, wherein the plurality of through channels (50) is provided in a monolithic piece of metal with the hot side flange plate (51) and the cold side flange plate (52) forming two face sides of the monolithic piece of metal.

12. The regenerator according to claim 10, wherein the hot side flange plate (51) is adapted for being attached to a heating means (8) for the hot side of the external heat engine (1) and wherein the cold side flange plate (52) is adapted for being attached to a cooling means (9, 91) for the cool side of the external heat engine (1).

13. The regenerator according to claim 1, wherein the taper of each through channel (50) is selected for use in combination with a gaseous working fluid (10).

14. The regenerator of claim 13, wherein the taper of each through channel (50) is selected for use in combination with air as the working fluid (10).

15. Stirling engine of the Alpha-type comprising a regenerator according to claim 1.
